(19) United States
(12) Patent Application Publication
(10) Pub. No.: US 2002/0082908 A1
(43) Pub. Date: Jun. 27, 2002

(54) System for automatically matching advertiser and target via network and the method of the same

(76) Inventors: Sheu Ren Yi, Hsinchu (TW); Jun Ching Wang, Tainan (TW)

Correspondence Address: Chun M. Ng, BLAKELY, SOKOLOFF, TAYLOR & ZAFMAN LLP, 7th Floor, 12400 Wilshire Boulevard, Los Angeles, CA, 90025, US

(21) Appl. No.: 09/731,564

(22) Filed: Dec. 6, 2000

(51) Int. Cl. G06F 17/60; G06G 7/00; G06F 17/00

(52) U.S. Cl. 705/14; 705/400

(57) ABSTRACT

A method for automatically matching an advertiser and a subscriber comprises setting a target including a target condition by the advertiser, wherein the target and the target condition are used to determine who will receive a delivered advertisement. Next, the advertiser forwards the target condition to a matching system. The matching system will forward the matched subscriber to the advertiser after matching. An advertisement is provided from the advertiser to the matching system and thereafter delivering the advertisement by the matching system to the matched subscriber.

### FIELD OF THE INVENTION

The present invention relates to a system for automatically matching an advertiser and target via a communication network, and more specifically, to a system for the advertiser oneself to determine the feedback reward to the subscriber for browsing the advertisement.

### BACKGROUND OF THE INVENTION

It is increasingly a requirement in modern computer systems to provide the capability to electronically communicate between computers to allow for shared transmission and manipulation of information. The most basic embodiment of conventional commerce consists of a salesman using a telephone and a facsimile machine to negotiate a sale with a customer. In this method, two parties negotiate the transaction, which may include, the quantity of goods to be purchased, the specifications of the merchandises, the payment terms and so on. It takes a lot of time. The conventional method of commerce offers limited practical advantages to their client. The business method is slow, time-intensive, and expensive to initiate and maintain.

Nowadays, the development of the internet is fast. The systems may be provided to perform an efficient, widely accessible, secure mechanism for conducting electronic commerce. The network is now a world wide information highway connecting most of the computer system the entire world. The user can interconnect with the network using various services such as electronic mail and World Wide Web (WWW). E-mail is one of the popular use tools, it is possible for computer system linked to internet for communicating each other. The World Wide Web (“WWW”) was designed as an easy visual interface for representatives of the internet. The WWW allows a server computer, called a Web site, to send graphical Web pages of information (Web pages) to a client computer and display the Web pages. These Web pages may contain control regions, such as simulated push buttons, that allow the representative to acquire and display additional, related Web pages of information in a hypertext fashion. Each client and server has an internet address called a Uniform Resource Locator (“URL”). The WWW uses the HTTP protocol. Currently, a Web page is defined by a HyperText Markup Language (“HTML”) file. The software on a client that manages the internet connections and interprets and effects the commands contained in HTML documents is called a browser. In general, the Web servers are stateless with respect to client transactions. The use and capabilities of the WWW have greatly increased in recent years.

The new advertising medium provided by the network has a number of significant advantages for advertisers. In general, the advertising can, in some instances, be targeted in various ways, such as demographically or reactively. An example of the latter of these is in push technology where the user requests certain types of information and this request is used to select the type of advertisement sent to the user along with the requested content. The advertising can not only include audio and video elements as well as simple visual elements, but can also be interactive. For example, by clicking on the advertisement, the user can be provided with additional information about the advertised products or services and can even be given the opportunity to purchase the products or services electronically.

Up to now, one of the most common methods of advertising is performed via the network. Some systems have been invented in the past to provide the function and apparatuses for targeting the delivery of advertisements over a network. Statistics are compiled on individual users and networks and the use of the advertisements is tracked to permit targeting of the advertisements of individual users. In response to requests from affiliated sites, an advertising server transmits to people accessing the page of a site an appropriate one of the advertisement based upon profiling of users and networks. One of the prior arts may be seen in the U.S. Pat. No. 5,948,061 to Merriman, et al., filed on Oct. 29, 1996, entitled “Method of delivery, targeting, and measuring advertising over networks”.

### SUMMARY OF THE INVENTION

Base on the previous discussion, the object of the present invention is to provide a system for matching the advertiser and the subscriber.

An object of the present invention is to provide a system for a advertiser to set one's expected condition for a certain target to be delivered, the system will forward to the advertiser when the subscriber meets the expected condition input by the advertiser.

A method for automatically matching an advertiser and a subscriber comprises setting a target including a target condition by the advertiser, wherein the target and the target condition are used to determine who will receive a delivered advertisement. Next, the advertiser forwards the target condition to a matching system. The matching system will forward the matched subscriber to the advertiser after matching. An advertisement is provided from the advertiser to the matching system and thereafter delivering the advertisement by the matching system to the matched subscriber.

The subscriber is determined to browse the advertisement or not after received the advertisement. The matching system will calculate a benefit paid by the advertiser after the subscriber browses the advertisement. Further, matching system also calculates a feed back reward to the subscriber by the matching system after the subscriber browses the advertisement. The target condition is set according to including but not limited to the subscriber's hobby, personal character, style, interesting and something like that. Wherein the feed back reward is calculated according to a percentage set by the advertiser.

A system for automatically matching a advertiser and a subscriber comprises a matching system to match the advertiser and the subscriber via a network. A storage device is coupled to the matching system to store an advertisement target database, wherein the advertisement target database includes target satisfaction data provided by the advertiser, and a desired advertisement type data provided by the subscriber. A communication module is responsive to satisfactions matching to forward to the advertiser.

### BRIEF DESCRIPTION OF THE DRAWINGS

FIG. 1 is a diagram of the matching system according to the present invention.

FIG. 2 is a flow chart diagram of a method for matching an advertiser and a subscriber according to the present invention.

FIG. 3 is a flow chart diagram of a method for a subscriber to set an advertisement mode according to the present invention.

### DETAILED DESCRIPTION

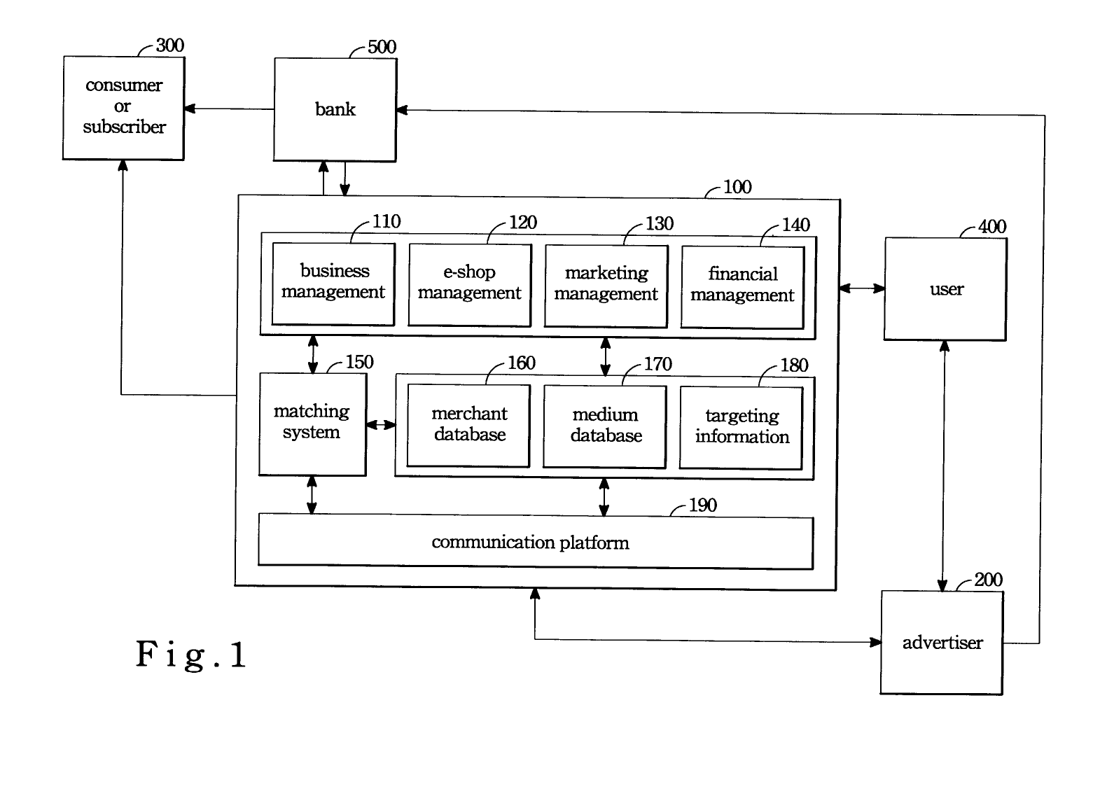

The present invention discloses a system for an advertiser to extract the potential client from public for improving the efficient of advertisement via a communication network. The present also provides a matching method based thereon. With reference to FIG. 1, there is illustrated a block diagram of the architecture of the advertisement targeting system 100 according to the present invention. The system serves as a central control system to send information to the advertiser or the consumer. The advertiser may successfully deliver the advertisement material to the consumer or subscriber via the matching system of the present invention. The present invention may be implemented using a computer having display screen and a positional input device. FIG. 1 shows an advertisement targeting system 100, which may include a management system having business management 110, e-shop management 120, marketing management 130 and financial management 140.

A matching system 150 matches the advertiser and the target consumer or subscriber. A database is coupled to the matching system 150 and the management system to store information. The database includes merchant database 160, the medium database and the targeting data (or information). The targeting information input by the advertiser 200 or the subscriber (consumer) 300. The advertiser 200 may set the target and the targeting condition. Information is exchanged between the server of the system 100 and the system of the advertiser 200 using the communication platform 190 over the communication links. In a preferred embodiment, the distributed information network is implemented on the internet.

The user who wished to deliver the advertisement has to access a terminal including processing unit such as CPU. The terminal of the advertiser 200 may be a computer, PDA, WAP mobile phone or the like. The terminal of the advertiser 200 is coupled to the advertisement targeting system 100 over the internet via the communication platform 190. Each advertiser 200 terminal includes one or more input/output devices that allow for the entry of target and the display of output. As known in the art, the advertiser 200 terminal also includes a storage device such as memory coupled to the processing unit. As well know in the art, the subscriber 300, other user 400 also contain aforementioned apparatus to access the function of the present invention.

In a preferred embodiment, the system 100 includes advertisement or medium database 170. The medium database 170 includes the information of the medium and/or the advertisement agent. The system 100 also includes the merchant database 160 that contains the information of the member-merchant.

The server exchanges information with the subscriber system over the communication links. The system manages the database, and the matching system 150 addresses advertisements to specifically targeted subscribers or consumer based on a subscriber's personal profile stored in the database of the system 100. The system also manages the distribution queue of the advertisements, and manages connections between the advertisement targeting system 100 and the subscriber 300, the advertiser 200.

The target information or target database 180 preferably further includes subscriber data, advertiser data, advertisement data, subscriber statistics, advertiser statistics. The subscriber data preferably includes the subscriber's identification information, a password assigned to the subscriber, and a personal profile of the subscriber that is used to target specific advertisements to the subscriber. The answers of the questionnaire are used to construct the subscriber's personal profile and is used to form the subscriber data stored in the target information 180. The advertiser data preferably includes identification information for each advertiser that provides advertisements to be distributed to the public.

When the system 100 establishes a connection with the advertiser 200, the targeting system 100 refreshes the queue of the advertisements to be delivered.

The financial management 140 or the matching system 150 calculates a benefit paid by the advertiser via the bank 500 for providing the service of matching the advertiser and subscriber after the subscriber browses the advertisement.

Then, the financial management 140 or the matching system 150 calculates a feed back reward to the subscriber 300 in accordance with a percentage of the benefit defined by the advertiser 200. An alternative method may be used to define the benefit for the target 300 and the advertisement matching system 100. For example, the advertiser may transfer the feed back benefit for the target to the advertisement matching system 100. The advertisement matching system 100 then deducts the deserved percentage of service fee from the feed back benefit. The remaining feed back benefit is transferred to the target who browsers the advertisement. The deserved percentage of service fee may be defined by the advertiser.

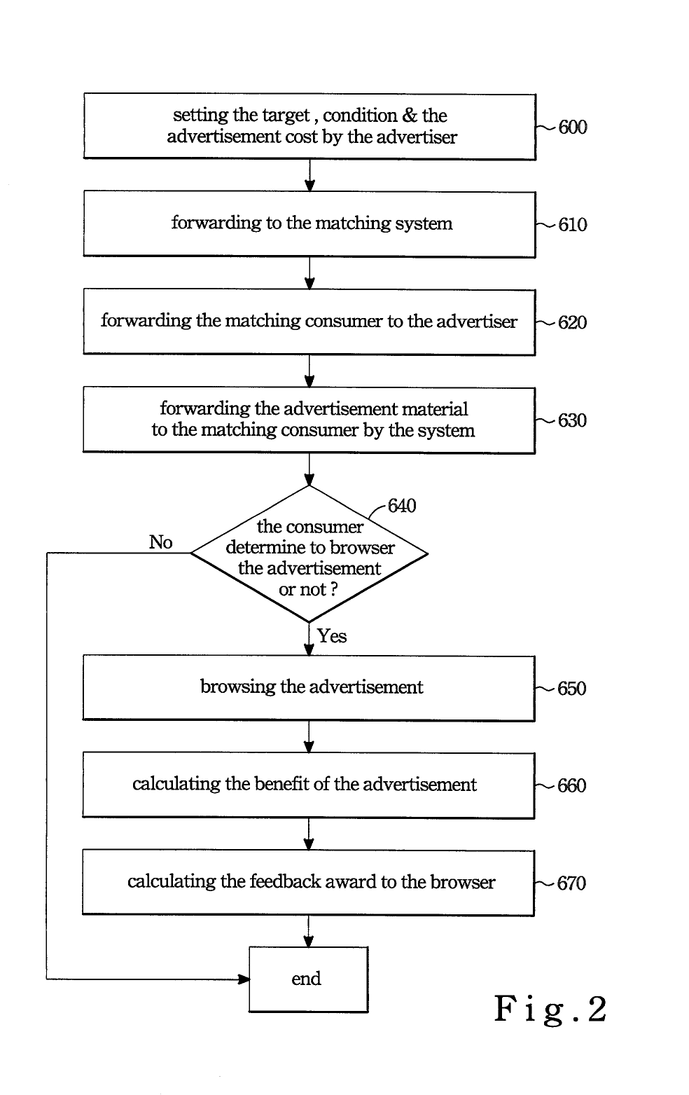

FIG. 2 is a flow chart in accordance with the present invention. The advertiser may enter satisfaction data including the target wish to be delivered at steps 600 to the targeting system 100 by the interface via network. In the step, the advertiser may set the target, target condition and the advertisement budget or cost. One of the feature according to the present invention is that the advertiser may set how many percentage of the budget will be fed back to the target who browsers the advertisement. Further, the advertiser may set the target condition to determine who will receive the delivered advertisement. Typically, it depends on the consumer's or subscriber's hobby, personal character, style, interesting and something like that.

Then, the advertiser 200 forwards the information to the matching system 100 of the present invention, step 610. It will be appreciated that any advertiser can enter one or more satisfaction information. The system 100 will records the information send from the advertiser 200 and stores the target satisfaction into the database. The satisfaction data is transmitted to the matching system 150, when ready for matching. The subscriber or consumer satisfaction, when ready for matching, is transmitted to the system 100 and stored in the database.

The satisfaction or condition is entered at each terminal, which is electronically transmitted to the system 100 and stored as files in the database of the system 100. In the representative embodiment, after the information of the advertiser or subscriber is input to the system, the system 100 actives the matching system 150 to monitor the matching satisfaction in the database. The matching system 150 monitors and calculates for each possible combination stored in the database. In the step 620, the matching system 150 determiners whether the updating information is match or not. A mutual satisfaction represents the potential for that satisfaction pair mutually to satisfy each other. The system 100 will forward the message to the advertiser 200.

At step 630, the advertiser then delivers the advertisement to the subscriber 300 via the matching system 150 using common network. The consumer or subscriber 200 may determine whether to browser the advertisement or not according to the feedback rewards defined by the advertiser 200 in step 360. The subscriber 300 may confirm the message and browse the advertisement in step 650. Otherwise, the subscriber 300 may refuse to read the advertisement.

Thereafter, the matching system 150 or the financial management 140 then calculates the service charge for delivering and matching the advertisement in a step 660 and the advertiser pays the service fee. Next, in step 670, the matching system 150 or the financial management 140 calculates the feed back award for the subscriber according to the previous condition set by the advertiser 200 in step 600.

A further feature of the present invention is that the present system 100 may provide the function for an individual who can not pay a great amount money to the advertise agent to promote or advertise his product for developing his marketing. The individual or any company may download the application software according to the present invention to determine what type of the advertisement to be received.

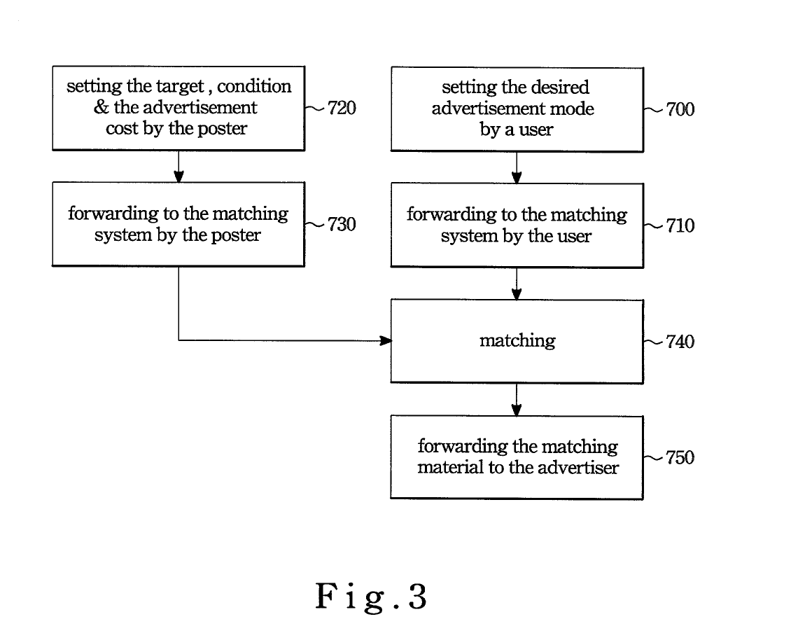

The user 400 or subscriber 300 may download the application software for performing the function provided by the advertisement matching system 100. Please refer to FIG. 3, in step 700, the user may set the desired advertisement mode and type wish to be received by using the application software and then forwards the selected information to the matching system in step 710. The desired advertisement mode includes but not limited to (1) the advertisement with feedback award, (2) the advertisement with coupon. For example, the advertisement type includes but not limited to mobile advertisement, cosmetic advertisement, real estate advertisement, commodity advertisement and so on. The user may subscribe what kind of the advertisement he would like to receive. In addition, the user may also decide to benefit from the coupon or feedback award when browsing the advertisement.

The advertiser in step 720 may set the target, target condition and the advertisement budget. Then, the advertiser may forward the set information to the matching system in step 730 via the common bus. In step 740, the system 100 actives the matching system 150 to monitor the matching pairs (step 740). Then, the matching system 150 forwards the matching material to the advertiser 200 and thereafter the advertisement will be delivered to the subscriber by the system 100.

Thus, the present invention includes a storage medium for the subscriber automatically to set the desired advertisement mode and type wish to be received, it comprises means for setting the mode of desired advertisement for receiving. Means for setting advertised advertisement type wish to be received, which allows the user to define a satisfaction level. Means for generating matching information, and means for forwarding to the system are coupled to the matching system.

The present invention also includes a storage medium for the advertiser to set the desired advertisement subscriber wish to be delivered. The storage medium comprises means for setting the desired advertisement target for delivering. Means for setting target condition wish to be delivered, which allows the advertiser to define a satisfaction level. Means for setting the feed back award to the subscriber. Means for generating matching information, and means for forwarding to the system are coupled to the matching system.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for automatically matching an advertiser and a subscriber comprises:
setting a target including a target condition by said advertiser, wherein said target and said target condition are used to determine who will receive a delivered advertisement;
forwarding said target condition to a matching system;
forwarding a matching target to said advertiser by said matching system after matching;
providing an advertisement by said advertiser to said matching system and thereafter delivering said advertisement by said matching system to said subscriber;
determining to browse said advertisement or not by said subscriber;
calculating a service charge for matching and delivering said advertisement after said subscriber browsing said advertisement; and
calculating a feed back benefit to said subscriber after said subscriber browsing said advertisement.

2. The method of claim 1, wherein said target condition is set according to a personal profile of said subscriber that is used to target specific advertisements to said subscriber, which includes but not limited to the subscriber's hobby, personal character, style, interesting and something like that.

3. The method of claim 1, wherein said feed back benefit is calculated according to a percentage set by said advertiser.

4. The method of claim 1, wherein said advertiser may transfer said feed back benefit for said subscriber to said advertisement matching system, said advertisement matching system then deducting a deserved percentage of service fee from said feed back benefit, a remaining feed back benefit being transferred to said subscriber who browsers said advertisement, wherein said deserved percentage of service fee may be defined by said advertiser.

5. The method of claim 1, further comprising:
setting a desired advertisement type wish to be received by said subscriber;
setting a desired advertisement mode wish to be received by said subscriber, wherein said advertisement mode includes but not limited to an advertisement with feedback award and an advertisement with coupon; and
forwarding said advertisement type and said advertisement mode to said matching system.

6. A storage medium for a subscriber to set a desired advertisement mode and type wish to be received, comprising:
means for setting a mode of desired advertisement for receiving;
means for setting an advertisement type wish to be received, which allows said subscriber to define a satisfaction level; and
means for generating matching information including said advertisement type and said mode of desired advertisement; and
means for forwarding said matching information to a matching system.

7. The storage medium of claim 6, wherein said mode of desired advertisement comprises an advertisement with feedback award and an advertisement with coupon.

8. A storage medium for an advertiser to set an advertisement subscriber wish to receive a delivered advertisement, comprises:
means for setting a desired advertisement target for delivering, which allows the advertiser to define a satisfaction level;
means for setting a feed back award to a subscriber;
means for generating matching information including said advertisement target; and
means for forwarding said matching information to a matching system.

9. The storage medium of claim 8, wherein said advertisement target is set according to a personal profile of said subscriber that is used to target specific advertisements to said subscriber, which includes but not limited to the subscriber's hobby, personal character, style, interesting and something like that.

10. A method for automatically matching an advertiser and a subscriber comprises:
providing an advertisement target database including target satisfaction data provided by said advertiser, and a desired advertisement type data provided by said subscriber;
matching said advertiser and said subscriber by a matching system using said target satisfaction data and said advertisement type data;
forwarding to said advertiser after a matching satisfaction is generated.

11. The method of claim 10, wherein said advertisement target is set according to a personal profile of said subscriber that is used to target specific advertisements to said subscriber, which includes but not limited to the subscriber's hobby, personal character, style, interesting and something like that.

12. The method of claim 10, wherein said advertisement target database further comprises an advertisement mode including an advertisement with feedback award and an advertisement with coupon.

13. A system for automatically matching an advertiser and a subscriber comprises:
a matching system to match said advertiser and said subscriber via a network;
a storage device coupled to said matching system to store an advertisement target database, wherein said advertisement target database includes target satisfaction data provided by said advertiser, and a desired advertisement type data provided by said subscriber;
a communication module responsive to a satisfactions matching performed by said matching system to forward to said advertiser.

14. The system of claim 13, wherein said advertisement target is set according to a personal profile of said subscriber that is used to target specific advertisements to said subscriber, which includes but not limited to the subscriber's hobby, personal character, style, interesting and something like that.

15. The system of claim 13, wherein said advertisement target database further comprises an advertisement mode including an advertisement with feedback award and an advertisement with coupon.

16. The system of claim 13, further includes merchant database coupled to said matching system.

17. The system of claim 13, further includes medium database coupled to said matching system.

18. The system of claim 13, further includes business management coupled to said matching system.

19. The system of claim 13, further includes shop management coupled to said matching system.

20. The system of claim 13, further includes marketing management coupled to said matching system.

21. The system of claim 13, further includes financial management coupled to said matching system.
